(19) United States
(12) Patent Application Publication
(10) Pub. No.: US 2013/0059148 A1
(43) Pub. Date: Mar. 7, 2013

(54) SOLAR-HEAT-BLOCKING COATING SOLUTION AND SOLAR-HEAT-BLOCKING COATED GLASS USING THE SAME

(71) Applicants: Hoon Hwang, Chungcheongbuk-do (KR); Ji-Hye Park, Gyeonggi-do (KR); Bong-Gyu Kim, Chungcheongbuk-do (KR)

(72) Inventors: Hoon Hwang, Chungcheongbuk-do (KR); Ji-Hye Park, Gyeonggi-do (KR); Bong-Gyu Kim, Chungcheongbuk-do (KR)

(73) Assignee: Nepes Rigmah., Ltd., Chungcheongbuk-do (KR)

(21) Appl. No.: 13/582,166

(22) PCT Filed: Aug. 20, 2010
(86) PCT No.: PCT/KR2010/005512

§ 371 Date: Nov. 16, 2012

(30) Foreign Application Priority Data
Mar. 2, 2010 (KR) 10-2010-0018590

(51) Int. Cl. C09D 5/33; B05D 5/06; B32B 17/06; C08K 5/101; C08K 3/22

(52) U.S. Cl. 428/336; 523/135; 428/428; 427/162

(57) ABSTRACT

A solar heat shielding coating solution is disclosed. The solar heat shielding coating solution comprises a sol-gel organic-inorganic composite binder solution and a nanosized metal oxide ink. The sol-gel organic-inorganic composite binder solution includes a sol-gel organic-inorganic composite resin, which is composed of a mixture of an acrylic polymer resin and a sol-gel silicate as an inorganic ceramic, and a solvent. The nanosized metal oxide ink includes a nanosized metal oxide, a dispersant capable of effectively dispersing the nanosized metal oxide, and a solvent. The coating solution can be coated to a small thickness on glass while maintaining transparency. In addition, the coating solution has high visible light transmittance, infrared light blocking rate and hardness, and exhibits good weather resistance, solvent resistance and adhesiveness. Due to these advantages, a coated glass product capable of shielding solar heat can be produced by directly coating the coating solution on glass, rather than by forming the coating solution into a film that is commonly used in the art. Further disclosed is a solar heat shielding coated glass product that is produced by directly coating the coating solution on glass.

### TECHNICAL FIELD

The present invention relates to a solar heat shielding coating solution and a solar heat shielding coated glass product. More particularly, the present invention relates to a solar heat shielding coating solution comprising a sol-gel organic-inorganic composite binder solution and a nanosized metal oxide ink wherein the sol-gel organic-inorganic composite binder solution includes a sol-gel organic-inorganic composite resin, which is composed of a mixture of an acrylic polymer resin and a sol-gel silicate as an inorganic ceramic, and a solvent, and wherein the nanosized metal oxide ink includes a nanosized metal oxide, a dispersant capable of effectively dispersing the nanosized metal oxide and an ink solvent. The present invention also relates to a solar heat shielding coated glass product that is produced by directly coating the coating solution on glass, rather than by forming the coating solution into a film that is commonly used in the art, to achieve excellent solar heat shielding properties.

### BACKGROUND ART

Generally, solar radiation is classified into gamma rays, X-rays, ultraviolet light, visible light, infrared light, microwaves and radio waves according to wavelength. Wavelengths we visually perceive as light are in the visible region and wavelengths we perceive as solar heat in our daily life are in the infrared region, which is longer in wavelength than light in the visible region. Typical glass reflects only a small portion of infrared light. Due to this incomplete reflection, radiant heat from the sun enters indoors, increasing the temperature of rooms in the summer season and infrared light emitted from indoor heaters escapes outside in winter, resulting in a decrease in the temperature of rooms. As a result, the efficiency of coolers and heaters deteriorates and energy consumption is thus increased. In view of this situation, there is a need for preferred glass products capable of preventing solar heat from entering indoors and preventing indoor heat from escaping outside. That is, there is a strong need for preferred glass products that can provide superior heat shielding properties and thermal insulation properties.

Solar reflective glass products have been used because of their excellent heat shielding properties. However, solar reflective glass products have a visible light transmittance as low as 40% and prevent a large portion of visible light from entering indoors. Thus, in winter, more energy is needed for room heating. For the purpose of improving heat shielding properties, a film is also attached to glass using an adhesive. In this case, however, the film tends to be detached from the glass when the adhesive loses adhesive strength. Further, the adhesive may remain on the film after removal of the film, making it hard to reuse the film. Further, it is difficult to control the light transmittance and reflectance of the film because the color of the film is generally limited. Low-emissivity glass products having improved thermal insulating effects have been introduced into the market. Such low-emissivity glass products are manufactured by sputtering coating. However, a low-emissivity glass product should be constructed such that a coating is interposed between a plurality of glass plates to be protected from oxidation and inert gas is filled between the glass plates. This construction procedure is complicated and requires edge striping equipment for manufacture of the multiple glass product, thus being troublesome in manufacture and handling and entailing considerable manufacturing costs.

Korean Patent No. 10-0909976, which was filed by the present applicant, describes a transparent color coating composition comprising a dispersed nanosized pigment and additives, and a method for preparing the composition. Specifically, the coating composition is prepared by mixing a nanosized organic pigment, a dispersant and a solvent to prepare a dispersion in which the organic pigment is stably dispersed at nanometer scale, and mixing the pigment dispersion with a sol-gel organic-inorganic composite resin solution as a binder. Coating of the coating composition on glass can provide a transparent colored glass product in which the organic pigment is stably dispersed at nanometer scale. In this patent, the sol-gel organic-inorganic composite resin solution is used as a binder for effectively binding the pigment dispersion, in which the nanosized organic pigment is stably dispersed, to a desired object. The use of the sol-gel organic-inorganic composite resin solution as a binder improves the hardness, adhesiveness and solvent resistance of the coating composition. The present applicant has attempted to prepare a transparent color coating composition further comprising a metal oxide to achieve improved heat shielding performance but has encountered great difficulty in presenting a preferred constitution for implementation.

JP 56-156606, JP 58-117228 and JP 63-281837 disclose a coating composition prepared by mixing antimony doped tin oxide (‘ATO’) with a binder resin or directly adding ATO to a solution of a resin binder in an organic solvent, a coating composition prepared by mixing an organic binder, tin oxide fine particles, an organic solvent and a surfactant, and a method of forming a solar light blocking coating by applying the coating composition. However, this coating should be sufficiently thick to ensure satisfactory infrared light blocking performance, and as a result, its transparency is inevitably deteriorated, indicating low visible light transmittance.

Aqueous resin binders, alcoholic resin binders, non-aqueous resin binders, functional coating compositions, films produced using the coating compositions, methods for preparing the binders, methods for preparing the coating compositions, and methods for forming the films have been presented in the prior art. The prior art compositions include fine functional particles uniformly dispersed in an amphoteric solvent and an acid for adjusting the surface charge of the fine functional particles. However, the dispersion procedure of the fine functional particles is complex and constituent resins of the binders for more stably binding the fine functional particles are not specified, which limits the crosslinking conditions of the resins resulting from the molding temperatures, polymerization conditions and curing conditions of the resins. There is thus a continued need for research and development to solve the problems of the prior art.

### DISCLOSURE

### Technical Problem

The present invention has been made in view of the problems of the conventional solar heat shielding coating solutions and techniques using the same. Thus, it is an object of the present invention to provide a solar heat shielding coating solution that eliminates problems encountered in the preparation of a solar heat shielding transparent color coating composition by further adding a metal oxide to a coating solution including a sol-gel organic-inorganic composite binder solution using a sol-gel organic-inorganic composite resin as a binder and an organic pigment dispersion; difficulties in dispersing a functional coating composition comprising fine functional particles uniformly dispersed in an amphoteric solvent and an acid for adjusting the surface charge of the fine functional particles; and limitations of the crosslinking conditions of resins constituting binders resulting from the molding temperatures, polymerization conditions and curing conditions of the resins because the resins for more stably binding fine functional particles are not specified. It is another object of the present invention to provide a coated glass product produced by directly coating the coating solution on glass.

### Technical Solution

In order to solve the above problems, the present invention provides a solar heat shielding coating solution comprising 10 to 97% by weight of a sol-gel organic-inorganic composite binder solution and 3 to 90% by weight of a nanosized metal oxide ink wherein the sol-gel organic-inorganic composite binder solution includes 50 to 80% by weight of a sol-gel organic-inorganic composite resin, which is composed of a mixture of an acrylic resin and a sol-gel silicate as an inorganic ceramic, and 20 to 50% by weight of a solvent, and wherein the nanosized metal oxide ink includes 1 to 70% by weight of a nanosized metal oxide having a particle size in the range of 10 to 200 nm, 1 to 10% by weight of a dispersant and 25 to 90% by weight of an ink solvent.

The present invention also provides a solar heat shielding coated glass product that is produced by coating the coating solution on glass.

### Advantageous Effects

The present invention offers the following effects. The coating solution of the present invention provides a preferred composition for shielding solar heat. When the coating solution of the present invention is coated on an object (a target to be coated), it exhibits improved resistance against external weather such as air and water, which is a problem of conventional solar heat shielding coating solutions. In addition, the coating solution of the present invention can overcome difficulties in dispersing a functional coating composition comprising fine functional particles uniformly dispersed in an amphoteric solvent and an acid for adjusting the surface charge of the fine functional particles. Furthermore, the coating solution of the present invention can eliminate limitations of the crosslinking conditions of resins constituting binders resulting from the molding temperatures, polymerization conditions and curing conditions of the resins because the resins for more stably binding fine functional particles are not specified. Moreover, the coating solution of the present invention can be coated to a small thickness while maintaining transparency, has high visible light transmittance, infrared light blocking rate and hardness, and exhibits good weather resistance, solvent resistance and adhesiveness. Due to these advantages, a coated glass product capable of shielding solar heat can be produced by directly coating the coating solution of the present invention on glass, rather than by forming the coating solution into a film that is commonly used in the art.

### DESCRIPTION OF DRAWINGS

FIG. 1 is a block diagram showing components constituting a solar heat shielding coating solution according to a preferred embodiment of the present invention; and

FIG. 2 shows UV-VIS-NIR spectra of non-treated glass, a coated glass product of Example 1 and a coated glass product of Example 2.

### BEST MODE

The present invention will now be described in detail.

The present invention is directed to a solar heat shielding coating solution, comprising 10 to 97% by weight of a sol-gel organic-inorganic composite binder solution and 3 to 90% by weight of a nanosized metal oxide ink wherein the sol-gel organic-inorganic composite binder solution includes 50 to 80% by weight of a sol-gel organic-inorganic composite resin, which is composed of a mixture of an acrylic resin and a sol-gel silicate as an inorganic ceramic, and 20 to 50% by weight of a solvent, and wherein the nanosized metal oxide ink includes 1 to 70% by weight of a nanosized metal oxide having a particle size in the range of 10 to 200 nm, 1 to 10% by weight of a dispersant and 25 to 90% by weight of an ink solvent.

The present invention is also directed to a solar heat shielding coated glass product that is produced by coating the coating solution on glass.

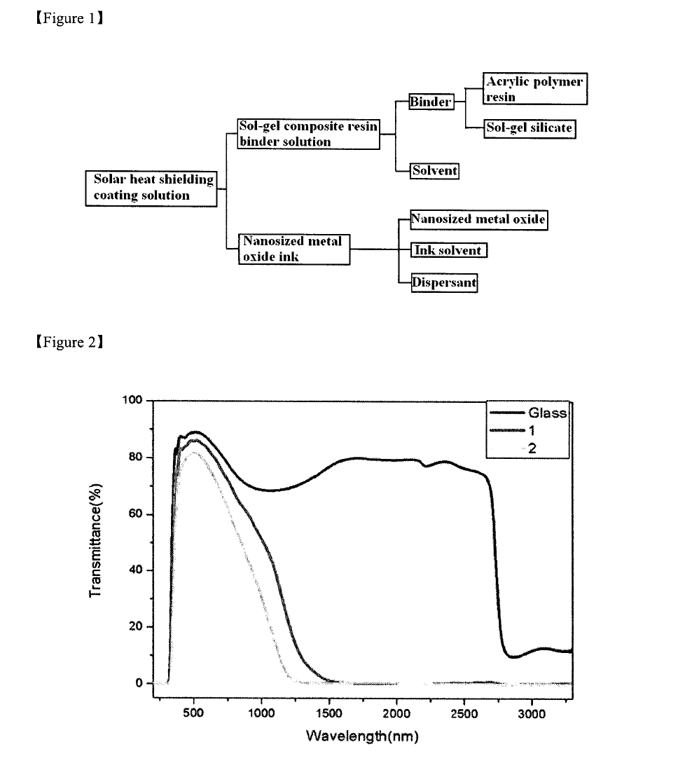

Hereinafter, the present invention will be specifically explained with reference to FIGS. 1 and 2.

<Solar Heat Shielding Coating Solution>

The coating solution of the present invention comprises a sol-gel organic-inorganic composite resin as a binder that has high pencil hardness, good adhesiveness and good solvent resistance. The sol-gel organic-inorganic composite resin is known to be composed of a mixture of an organic acrylic copolymer resin and a sol-gel silicate as an inorganic ceramic synthesized by the reaction of a metal colloidal sol and a silane.

The sol-gel organic-inorganic composite binder solution is prepared by mixing 50 to 80% by weight of a sol-gel organic-inorganic composite resin composed of a mixture of an acrylic polymer resin and a sol-gel silicate as an inorganic ceramic with 20 to 50% by weight of a solvent. The sol-gel organic-inorganic composite binder solution allows a nanosized metal oxide ink including a nanosized metal oxide to be uniformly distributed on an object and enables the nanosized metal oxide ink to be effectively and stably bound to the object. Taking into consideration the adhesion of the nanosized metal oxide ink to an object (e.g., glass) to be coated and the plasticity of the nanosized metal oxide ink, the sol-gel organic-inorganic composite binder solution is highly transparent and improves the physical strength such as hardness, adhesiveness and solvent resistance) of the coating solution.

Particularly, the sol-gel organic-inorganic composite binder solution includes a solvent for diluting the sol-gel organic-inorganic composite resin. The selection and mixing ratio of the solvent can be suitably determined taking into consideration the finger touch drying time, the occurrence of defects such as fluidity, melt bonding of the coating, the formation of mud cracks, etc. The solvent may be at least one organic solvent selected from the group consisting of diethylene glycol monoethyl ether acetate, propylene glycol monomethyl ether, propylene glycol monomethyl ether acetate, propylene glycol monoethyl ether, propylene glycol monoethyl ether acetate, methyl cellosolve, ethyl cellosolve, epoxypropionic acid, xylene, toluene, ethyl acetate, methyl acetate, butyl acetate, methyl ethyl ketone, cyclohexanone, butanol, ethanol, methanol and isopropanol. The solvent is preferably a mixture of a non-polar solvent and a polar solvent because the acrylic polymer resin is hydrophobic and the sol-gel silicate compound as an inorganic ceramic is hydrophilic.

A sol-gel organic-inorganic composite binder of the prior art reacts with a functional group of a base present in a dispersant surrounding a nanosized organic pigment. Since this reaction may deteriorate the dispersion stability of the organic pigment, the dispersant is limited to one having a low or no amine value, which is advantageous in uniformly and stably dispersing the pigment dispersion in an organic-inorganic composite resin solution without aggregation of the organic pigment. In contrast, the sol-gel organic-inorganic composite binder solution used in the present invention serves to improve the physical strength (e.g., hardness, adhesiveness and solvent resistance) of the coating solution, taking into consideration the adhesion of the nanosized metal oxide ink including the nanosized metal oxide to glass and plasticity of the nanosized metal oxide ink.

The present invention is also directed to a method for preparing the solar heat shielding coating solution comprising 10 to 97% by weight of the sol-gel organic-inorganic composite binder solution and 3 to 90% by weight of the nanosized metal oxide ink. If the nanosized metal oxide ink is present in an amount of less than 3% by weight, the coating solution cannot exhibit satisfactory infrared light blocking properties and the nanosized metal oxide is not sufficiently dispersed. This insufficient dispersion leads to an increase in the particle size of the nanosized metal oxide and causes the occurrence of haze, making glass to be coated with the coating solution opaque. Meanwhile, if the nanosized metal oxide ink is present in an amount of more than 90% by weight, the physical properties (e.g., adhesiveness) of the coating solution are deteriorated due to the relatively low content of the binder. Therefore, it is preferred to limit the content of the nanosized metal oxide ink to the range defined above.

The nanosized metal oxide ink is prepared by mixing the nanosized metal oxide with an ink solvent in the presence of a dispersant to effectively disperse the nanosized metal oxide. Specifically, it is preferred that the nanosized metal oxide ink include 1 to 70% by weight of the nanosized metal oxide, 1 to 10% by weight of the dispersant and 25 to 90% by weight of the ink solvent. If the nanosized metal oxide is present in an amount of less than 1% by weight, the infrared light blocking effects of the nanosized metal oxide are not sufficiently exhibited. Meanwhile, if the nanosized metal oxide is present in an amount exceeding 70% by weight, much time is required to control the particle size of the nanosized metal oxide and there is a difficulty in suitably dispersing the nanosized metal oxide. Therefore, it is preferred to limit the content of the nanosized metal oxide to the range defined above.

The nanosized metal oxide, which is a main material of the nanosized metal oxide ink, has the ability to block sunlight in the infrared region. The nanosized metal oxide is not particularly limited because most nanosized metal oxides have a regular structure in which intermolecular spacings are constant, thus blocking a large portion of light in the infrared region due to the presence of metal bonds. The nanosized metal oxide is preferably tin oxide, indium tin oxide (ITO), antimony tin oxide (ATO), aluminum oxide (Al₂O₃), zinc oxide (ZnO), titanium oxide (TiO₂), or a mixture thereof.

More preferably, the nanosized metal oxide is ITO in which tin is present in an amount of 5 to 20% by weight relative to the indium content or ATO in which tin is present in an amount of 5 to 30%. ITO or ATO having the above composition does not cause substantial deterioration of infrared light blocking effects when bonded to the resin and can block infrared light over a broad range of wavelengths from the near infrared light region close to the visible region while maintaining the visible light transmittance at a high level.

The particle size of the nanosized metal oxide does not have a significant influence on the solar heat shielding effects of the coating solution. If the coating solution comprising the nanosized metal oxide having a particle size smaller than 10 nm is coated on glass, the nanosized metal oxide is not readily dispersed. Meanwhile, if the coating solution comprising the nanosized metal oxide having a particle size lager than 200 nm is coated on glass, haze may occur. This haze lowers the visible light transmittance of the coating and makes the coating surface non-uniform. Accordingly, it is preferred to limit the particle size of the nanosized metal oxide to the range of 10 to 200 nm.

The dispersant serving to effectively disperse the nanosized metal oxide is preferably 2-[2-(2-methoxyethoxy)ethoxy]acetic acid, 5-methoxypentyloxy acetic acid, 3,6,9-trioxadecanoic acid, palmitic acid, stearic acid, propionic acid, sodium polyacrylate, ammonium polyacrylate, cetyltrimethylammonium bromide (CTAB), polyacrylic sodium salt, dodecyl benzene sulfonate, sodium dodecyl sulfate (SDS) or a mixture thereof. The dispersant is generally a surfactant consisting of at least one functional group adsorbed to the nanosized metal oxide and at least one carbon chain bonded to the functional group. The functional group is selected from carboxylic acid (R—COOH), carboxylate (R—COO—), alcohol (R—OH), glycol (R—(OH)₂), ammoniate (R—NH³⁺), sodium salt (R—Na⁺), sulfonate (R—SO₃⁻) and sulfate (SO₄²⁻). The carbon chain is selected from alkyl (—R) and alkoxy (—OR).

The functional group of the dispersant having the above structure has an affinity for the surface of the nanosized metal oxide. This affinity allows the nanosized metal oxide to be adsorbed to the surface of the dispersant, ensuring effective dispersion of the nanosized metal oxide in the solvent. The carbon chain such as alkyl (—R) or alkoxy (—OR) serves to stabilize the adsorbed nanosized metal oxide in the solvent. Due to this molecular structure, the dispersant is advantageous in terms of dispersibility and stability as compared to general dispersants.

The solvent used for the preparation of the nanosized metal oxide ink may be a compound represented by R1-O-R2 or R1-CO-R2, for example, water, methanol, butyl glycol, isopropyl glycol, aryl glycol, ethyl acetate, dibutyl ether, methyl ethyl ketone or dimethylformamide. The kind of the solvent is determined taking into consideration the characteristics of the ink, for example, dispersibility, stability, toxicity, viscosity, chemical stability, ease of thin film coating and drying conditions.

As the number of the carbon atoms of the substituents R1 and R2 increases, the molecular volume of the solvent increases and the number of electrons in the solvent increases. Thus, asymmetry of electron distribution in the molecule of the solvent increases, leading to the occurrence of polarization. This polarization increases the dispersion ability of the ink solvent molecules and induces electrostatic induction of the nanosized metal oxide and the ink solvent molecules, causing aggregation of the molecules. This phenomenon impedes effective dispersion of the nanosized metal oxide particles in the nanosized metal oxide ink. In view of the foregoing, it is preferred that the substituents R1 and R2 of the solvent be each independently a hydrogen atom, a C₁-C₁₀ n-alkyl, iso-alkyl, heteroaryl or aryl group, or an ether, ester or amide group substituted with a C₁-C₁₀ alkyl group. The solvent having such substituent structures has a substituent volume and electrons that do not cause aggregation of the nanosized metal oxide particles by the dispersion ability of the constituent molecules.

For better dispersion of the nanosized metal oxide in the solvent, mechanical processing such as bead milling, ball milling or ultrasonic milling can be used. This mechanical processing prevents the dye from aggregating due to the attractive force between the nanosized metal oxide particles, achieving more effective and uniform dispersion.

<Solar Heat Shielding Coated Glass Product>

The solar heat shielding coated glass product of the present invention is produced by coating the surface of glass with the coating solution. Specifically, the coated glass product of the present invention is produced through the following steps.

1. Preparation of the Solar Heat Shielding Coating Solution
In this step, the solar heat shielding coating solution is prepared. Details of the solar heat shielding coating solution are described above, and a repeated explanation thereof is omitted here.

2. Coating of the Solar Heat Shielding Coating Solution on Glass Surface
In this step, the solar heat shielding coating solution prepared in step 1 is coated on the surface of glass. Examples of techniques suitable for coating the coating solution on the glass surface include, but are not particularly limited to, spray coating, dip coating, slot die coating, flow coating, spin coating and inkjet coating. Coating of the coating solution by one of the above-mentioned coating techniques enables the formation of the nanosized metal oxide at a uniform thickness of a few nanometers to a few hundreds of micrometers, so that desired physical properties can be obtained in terms of visible light transmittance and infrared light blocking rate. It is preferred to coat the coating solution to a thickness of 1 to 10 μm. Coating of the coating solution comprising less than 20% by weight of the nanosized metal oxide to a thickness smaller than 1 μm is not effective in blocking infrared light. Meanwhile, coating of the coating solution to a thickness larger than 10 μm is undesirable in terms of transparency and visible light transmittance. Since there is no significant difference in visible light blocking effect between a coating having a thickness smaller than 10 μm and a coating having a thickness larger than 10 μm, it is preferred to limit the coating thickness to the range defined above.

3. Drying of the Glass Coated with the Coating Solution
In this step, the glass coated in step 2 is dried. Examples of techniques suitable for drying the coated glass include, but are not limited to, NIR drying, hot air drying and hot plate drying. Rapid drying of the coating solution coated on the glass surface at a temperature of 250° C. or higher may make the coating solution cause structurally unstable, and as a result, changes in physical properties such as bending of the coating surface and surface cracks may be observed. Slow drying of the coating solution at a temperature of 50° C. or lower creates nuclei in the coating solution, and as a result, impurities may aggregate around the nuclei to form crystals, which are causes of haze. In view of the foregoing, it is preferred to perform the drying of the coating solution at a temperature of 50 to 250° C. for 10 to 60 minutes. By the use of the sol-gel organic-inorganic composite binder solution, drying and curing of the coating solution are enabled simultaneously through the heat drying, thereby advantageously contributing to the simplification of the production procedure. As a result, the coated glass product can be produced at low cost.

### MODE FOR INVENTION

Hereinafter, the coating solution and the coated glass product of the present invention will be explained with reference to the following examples and comparative examples. Compositions of the inventive coating solutions are summarized in Table 1. These examples are provided for illustrative purposes only and are not intended to limit the scope of the present invention.

### Example 1

1. 15.2 g of an acrylic polymer resin (MIO-YO67G), 3.8 g of a sol-gel silicate (EC) as an inorganic ceramic, and 19 g of PGMEA as a solvent are mixed to prepare 38 g of a sol-gel organic-inorganic composite binder solution. 19.2 g of ITO having an average particle size of 70 nm as a nanosized metal oxide, 1.2 g of 5-methoxypentyloxy acetic acid as a dispersant and 25.7 g of butyl glycol as a solvent are mixed to prepare 46.1 g of a nanosized metal oxide ink. The sol-gel organic-inorganic composite binder solution is mixed with the nanosized metal oxide ink to prepare a solar heat shielding coating solution.

2. The coating solution is filled in a sprayer and is then spin-coated to a thickness of 3 μm on one surface of 6 mm thick transparent glass which was previously wiped clean.

3. The glass coated with the coating solution is charged into an oven at 180° C. and dried for 30 min to produce a solar heat shielding coated glass product.

### Example 2

1. 15.2 g of an acrylic polymer resin (MIO-YO67G), 3.8 g of a sol-gel silicate (EC) as an inorganic ceramic, and 19 g of PGMEA as a solvent are mixed to prepare 38 g of a sol-gel organic-inorganic composite binder solution. 9.2 g of ITO having an average particle size of 70 nm as a nanosized metal oxide, 0.2 g of 5-methoxypentyloxy acetic acid as a dispersant and 5.1 g of butyl glycol as a solvent are mixed to prepare 9.1 g of a nanosized metal oxide ink. The sol-gel organic-inorganic composite binder solution is mixed with the nanosized metal oxide ink to prepare a solar heat shielding coating solution.

2. The coating solution is coated on glass surface in the same manner as in Example 1.2.

3. The glass coated with the coating solution is dried in the same manner as in Example 1.3 to produce a solar heat shielding coated glass product.

### Example 3

1. A solar heat shielding coating solution is prepared in the same manner as in Example 2.1.

2. The coating solution is filled in a sprayer and is then spin-coated to a thickness of 0.8 μm on one surface of 6 mm thick transparent glass which was previously wiped clean.

3. The glass coated with the coating solution is dried in the same manner as in Example 1.3 to produce a solar heat shielding coated glass product.

### Example 4

1. A solar heat shielding coating solution is prepared in the same manner as in Example 1.1.

2. The coating solution is filled in a sprayer and is then spin-coated to a thickness of 10.5 μm on one surface of 6 mm thick transparent glass which was previously wiped clean.

3. The glass coated with the coating solution is dried in the same manner as in Example 1.3 to produce a solar heat shielding coated glass product.

### Comparative Example 1

1. A heat shielding film purchased from M Company is attached to one surface of 6 mm thick transparent glass which was previously wiped clean.

### Comparative Example 2

1. A heat shielding film purchased from T Company is attached to one surface of 6 mm thick transparent glass which was previously wiped clean.

TABLE 1

| | Components | | | Ex. 1 | Ex. 2 | Ex. 3 | Ex. 4 |
|---|---|---|---|---|---|---|---|
| Sol-gel organic- | Sol-gel organic- | Acrylic polymer | MIO- | 15.2 | 15.2 | 15.2 | 15.2 |
| inorganic | inorganic composite | resin | Y067G⁽¹⁾ | | | | |
| composite binder | binder | Sol-gel silicate | EC⁽²⁾ | 3.8 | 3.8 | 3.8 | 3.8 |

| | | | | | | |
|---|---|---|---|---|---|---|
| solution | Organic solvent | PGMEA⁽³⁾ | 19.0 | 19.0 | 19.0 | 19.0 |
| Nanosized metal | Nanosized metal oxide | ITO⁽⁴⁾ | 19.2 | 3.8 | 3.8 | 19.2 |
| oxide ink | (average particle size = | | | | | |
| | 70 nm) | | | | | |
| | Dispersant | 5-methoxypentyloxy acetic acid | 1.2 | 0.2 | 0.2 | 1.2 |
| | Ink solvent | Butyl glycol | 25.7 | 5.1 | 5.1 | 25.7 |

| | | | | |
|---|---|---|---|---|
| Coating thickness (μm) | 3.0 | 3.0 | 0.8 | 10.5 |

⁽¹⁾MIO-Y067G: Binder for glass (solid content = 50 wt %) manufactured by DNC
⁽²⁾EC: Ethyl cellosolve
⁽³⁾PGMEA: Propylene glycol monomethyl ether acetate
⁽⁴⁾ITO: Indium doped tin oxide

[Method for Evaluation of Physical Properties]

The coated glass products of Examples 1-4 and Comparative Examples 1-2 and non-treated glass of the same material as the glass of the coated glass products are evaluated for physical properties by the following methods.

(1) Visible Light Transmittance (VIS.T %)/Infrared Light Transmittance (IR.T %)

VIS.T % and IR.T % are measured using a UV/VIS/NIR spectrometer (Cary 5000)

(2) Hardness

Hardness is measured using a Mitsubishi pencil under the following conditions: load=1 kg, angle=45°, rate=50 mm/min, moving distance=100 mm

(3) Adhesiveness

Each of the coatings is cut at intervals of 1 mm in both the widthwise and lengthwise directions to form 100 blocks. The resulting coated glass product is dipped in boiling water at 100° C. for 30 min and taken out of the water. A cellophane tape is uniformly attached on the surface. After the cellophane tape is detached suddenly from the surface, the number of the remaining blocks is counted.

(4) Solvent Resistance

After a cloth dipped in ethanol is reciprocated 100 times over each specimen, the state of the specimen is observed visually.

[Results]

The obtained results are shown in Table 2. As can be seen from the results in Table 2, most wavelengths in the visible region penetrate through the non-treated glass, which appears to be transparent. Wavelengths in the UV and infrared regions are absorbed to some extent in the non-treated glass, but the visible and UV light blocking effects of the non-treated glass are negligible. The coating solutions of Examples 1 and 2 have different compositions. The coating solution of Example 1 shows better infrared light blocking effects than the coating solution of Example 2, which includes a smaller amount of the nanosized metal oxide ink than the coating solution of Example 1. The coating solutions of Examples 1, 3 and 4 have the same composition and are coated and dried by the same methods. The coating solution of Example 3 is less effective in blocking infrared light than the coating solution of Example 2, which has a smaller coating thickness than the coating solution of Example 3. In addition, it can be seen that most infrared light can be blocked when the coating solution is coated to above a predetermined thickness (see Example 4). The coating solutions of Examples 1-4 show higher infrared light blocking rates, higher hardness values, better adhesiveness and better solvent resistance due to the presence of the sol-gel organic-inorganic composite binder solution than the coating solutions of Comparative Examples 1-2.

TABLE 2

| | VIS.T % | IR.T % | | Adhe- | Solvent |
|---|---|---|---|---|---|
| | (520 nm) | (1200 nm) | Hardness | siveness | resistance |
| Example 1 | 82 | 0 | 8 H | 100/100 | o |
| Example 2 | 87 | 15 | 8 H | 100/100 | o |
| Example 3 | 85 | 40 | 8 H | 100/100 | o |
| Example 4 | 72 | 0 | 8 H | 100/100 | o |
| Comparative | 69 | 4 | 2 H | 46/100 | x |
| Example 1 | | | | | |
| Comparative | 48 | 4 | 2 H | 53/100 | x |
| Example 2 | | | | | |
| Non-treated | 88 | 69 | — | — | — |
| glass | | | | | |

Solar heat shielding coating solutions are prepared in the same manner as in Example 1. The coating solutions are applied to glass surface by spin coating and dried in an oven at different temperatures for 30 min. The surface bending, haze and cracks are observed. The results are shown in Table 3.

TABLE 3

| | Temp. (° C.) | | | | | | | |
|---|---|---|---|---|---|---|---|---|
| Surface state | 20 | 60 | 100 | 140 | 180 | 220 | 260 | 300 |
| Surface bending | A | ∘ | ∘ | ∘ | ∘ | Δ | Δ | x |
| Surface haze | x | ∘ | ∘ | ∘ | ∘ | Δ | Δ | Δ |
| Surface cracks | ∘ | ∘ | ∘ | ∘ | ∘ | ∘ | x | xx |

In this test, glass products spin-coated with solar heat shielding coating solutions prepared in the same manner as in Example 1 are used.
Drying is performed for the same time (30 min).
Surface bending and cracks are phenomena arising when the physical properties of the coating solutions are changed and surface haze is a phenomenon arising when the coating solutions are damaged by aggregation of impurities
Since conventional standards for the evaluation surface bending, cracks and haze are unclear, the surface states of the coating solutions are visually evaluated based on the following criteria:
∘: good,
Δ: average,
x: damaged,
xx: seriously damaged

The coated glass products produced under the same conditions are dried at different temperatures shown in Table 3 for 30 min. When the coating solution is not sufficiently dried at a temperature lower than 50° C., surface bending and cracks are not detected but surface haze is observed, resulting in deterioration of transparency. When the coating solutions are dried at temperatures higher than 250° C., surface bending and cracks are observed with the occurrence of slight surface haze. From these results, it can be confirmed that optimum coating effects can be obtained at drying temperatures of 50 to 250° C. without changes in the physical properties of the coating solutions and damage to the coating solutions.

Examples of glass applicable to the solar heat shielding coated glass product of the present invention include silica glass and functional glass such as color glass, reinforced glass and bulletproof glass. Although the present invention has been described herein with reference to the preferred embodiments, these embodiments do not serve to limit the scope of the present invention. Accordingly, those skilled in the art to which the present invention pertains will appreciate that various modifications are possible, without departing from the spirit of the present invention.

1. A solar heat shielding coating solution, comprising 10 to 97% by weight of a sol-gel organic-inorganic composite binder solution and 3 to 90% by weight of a nanosized metal oxide ink wherein said sol-gel organic-inorganic composite binder solution includes 50 to 80% by weight of a sol-gel organic-inorganic composite resin composed of a mixture of an acrylic resin and a sol-gel silicate, and 20 to 50% by weight of a solvent.

2. The solar heat shielding coating solution according to claim 1, wherein said nanosized metal oxide ink includes 1 to 70% by weight of a nanosized metal oxide having a particle size in the range of 10 to 200 nm, 1 to 10% by weight of a dispersant, and 25 to 90% by weight of an ink solvent

3. The solar heat shielding coating solution according to claim 2, wherein said dispersant is a surfactant consisting of at least one functional group capable of being adsorbed to the metal oxide and at least one carbon chain of alkyl (—R) and alkoxy (—OR), the functional group being selected from carboxylic acid (R—COOH), carboxylate (R—COO—), alcohol (R—OH), glycol (R—(OH)₂), ammoniate (R—NH³⁺), sodium salt (R—Na⁺), sulfonate (R—SO₃⁻) and sulfate (SO₄²⁻).

4. The solar heat shielding coating solution according to claim 3, wherein said dispersant is at least one of 2-[2-(2-methoxyethoxy)ethoxy]acetic acid, 5-methoxypentyloxy acetic acid, 3,6,9-trioxadecanoic acid, palmitic acid, stearic acid, propionic acid, sodium polyacrylate, ammonium polyacrylate, cetyltrimethylammonium bromide (CTAB), polyacrylic sodium salt, dodecyl benzene sulfonate, sodium dodecyl sulfate (SDS).

5. The solar heat shielding coating solution according to claim 2, wherein said nanosized metal oxide is at least one of tin oxide, indium tin oxide (ITO), antimony tin oxide (ATO), aluminum oxide (Al₂O₃), zinc oxide (ZnO), titanium oxide (TiO₂).

6. The solar heat shielding coating solution according to claim 2, wherein said ink solvent is a compound represented by R1-O-R2 or R1-CO-R2 in which the substituents R1 and R2 each independently have a hydrogen atom, a C₁-C₁₀ n-alkyl, iso-alkyl, heteroaryl or aryl group, or an ether, ester or amide group substituted with a C₁-C₁₀ alkyl group.

7. The solar heat shielding coating solution according to claim 6, wherein said ink solvent is at least one of water, methanol, butyl glycol, isopropyl glycol, aryl glycol, ethyl acetate, dibutyl ether, methyl ethyl ketone, dimethylformamide.

8. A solar heat shielding coated glass product produced by the following steps:
preparing a solar heat shielding coating solution comprising 10 to 97% by weight of a sol-gel organic-inorganic composite binder solution and 3 to 90% by weight of a nanosized metal oxide ink;
coating the coating solution to a predetermined thickness on the surface of glass; and
drying the glass coated with the coating solution.

9. The solar heat shielding coated glass product according to claim 8, wherein said coating solution is applied to a thickness of 1 to 10 μm.

10. The solar heat shielding coated glass product according to claim 8, wherein said coated glass is dried at a temperature of 50 to 250° C. for 10 to 60 minutes by at least one drying method of NIR drying, hot air drying and hot plate drying.
